(19) United States
(12) Patent Application Publication
(10) Pub. No.: US 2003/0025322 A1
(43) Pub. Date: Feb. 6, 2003

(54) Business form with label having improved stacking

(76) Inventor: Mark Casper, Williamsville, NY (US)

Correspondence Address: NIXON & VANDERHYE P.C., 8th Floor, 1100 North Glebe Rd., Arlington, VA, 22201-4714, US

(21) Appl. No.: 09/922,736

(22) Filed: Aug. 7, 2001

(51) Int. Cl. B42D 15/00; B32B 31/00

(52) U.S. Cl. 283/101; 156/250; 156/247

(57) ABSTRACT

A business form and method of constructing a business form suitable for variable printing, including: a first portion including at least one removable label on a label portion thereof, and an attaching portion extending rearwardly from the label portion, wherein said label portion has a thickness that is greater than a thickness of said attaching portion; and a second portion made substantially of a single sheet that can be printed thereon by a cut sheet printer. A bottom surface of a forward edge of said second portion is secured to a top surface of a rear edge of said attaching portion in a manner that defines an overlapping portion of said business form that is adjacent to said label portion. The overlapping portion has a thickness that substantially corresponds to the thickness of the label portion.

### FIELD OF THE INVENTION

The instant invention relates to business forms and the like having an integral and removable label and, more particularly, to an improved printer blank business form with one or more labels thereon, wherein the form is designed to improve the stackability of the forms when used in a cut sheet device, such as a laser printer.

### BACKGROUND OF THE INVENTION

Various business forms and the like with integral labels thereon have been provided in the past as evidenced by, for example, U.S. Pat. Nos. 5,893,958 and 5,507,901. These and other similar patents disclose a form product with an integrated label component. Such forms with integrated labels are useful for many applications, such as pharmacy applications and the like. For example, forms with integrated labels can be used by a pharmacy to print information for the customer on the plain paper portion of the form and to print other important or useful information on the label portion of the form. The printed label portion can then be removed and applied to, for example, a prescription product. Such printable and removable labels have many applications and have been found to be convenient and useful when provided on a form for a variety of applications.

FIG. 1a shows a top view of a first side of an exemplary form blank with integrated label to which the instant invention is applicable. This exemplary form blank of FIG. 1a is in the form of a sheet 10, such as an 8.5×14 inch sheet. The sheet 10 includes a first portion 12 comprised of standard paper that can be printed on or which may also include pre-printed information or other indicia. A second portion 14 of the sheet 10 is a label portion of the sheet 10 and includes a removable label or a plurality of die cut removable labels. The label(s) are designed to be removable from the sheet 10 so that they can be applied to a particular item depending on the particular application for which the sheet 10 is designed. FIG. 1a shows a liner element 16 for supporting the labels 18 on the sheet 10. The labels are preferably pressure-sensitive adhesive labels that can easily be peeled off the liner and re-applied to another object, such as, but not limited to, a pharmacy bottle, file or the like.

The plain paper portion 12 of the sheet 10 may include score lines, such as lines 20, 22 and 24 to enable the form to be folded or separated into individual components defined by the score lines. For example, section 12a of the plain paper portion 12 may be used to print useful or educational information for the consumer, and section 12b may be a coupon that the customer may be able to remove and use under certain requirements. The plain paper section 12 can be used for a variety of applications depending on the particular needs or desires for a particular application. The configuration of sheet 10 of FIGS. 1a and 1b is only exemplary and may come in a variety of shapes, sizes and overall configurations. The important point is that the form include a plain paper or substantially single layer portion and a label portion.

FIG. 1b shows the second side of the exemplary form blank of FIG. 1a. As can be seen in FIG. 1b, the label portion 14 may include a plurality of die cut labels (e.g., 18a, 18b, 18c), each of which can be individually removed from the sheet 10 for application to another object as desired. The label portion 14 and the plain paper portion 12 are preferably designed to enable printing thereon by, for example, a laser printer or the like.

FIG. 1c shows a side view of the exemplary printer blank or form 10. As can be seen in FIG. 1c, the label portion 14 of form 10 includes a liner 16, a adhesive layer 26 a silicon layer 28 and the removable label(s) 18. In contrast, the plain paper portion 12 of the form 10 includes only a single paper layer. Due to the fact that the label portion 14 includes several layers (i.e., layers 16, 26, 28 and 18), the thickness of the label portion 14 of the sheet 10 is significantly thicker than the plain paper portion 12 of the sheet 10. As a result, a step 30 is defined between the plain paper portion 12 and the label portion 14 of the sheet 10. It is noted that the difference in height between the plain paper portion and the label portion is somewhat exaggerated in the FIG. 1c, but nevertheless a step 30 is present between the plain paper portion and the label portion of the sheet 10.

FIG. 2 demonstrates a problem that exists as a result of the design of printer blanks such as the sheet 10 of FIGS. 1a-1c. Specifically, FIG. 2 depicts a first sheet 10a, constructed in the manner described above, resting in an output tray (not shown) or the like of a laser printer (not shown) or other cut sheet processing device. FIG. 2 further shows a second sheet 10b being output in the direction indicated by arrow 34 from the same cut sheet processing device for stacking on the first sheet 10a. In other words, FIG. 2 represents a typical situation where cut sheet forms are being successively processed through a laser printer and output to a holding tray or the like one at a time after processing. A problem with prior art forms, such as described above with respect to FIGS. 1a and 1b, is that the forward edge 32 of the second sheet 10b tends to get caught on the rear edge 36 of the first sheet 10a as the second sheet slides across the first sheet. In other words, the step 30 defined by the greater thickness of the label portion 14 of the sheet 10 relative to the plain paper portion 12 makes it difficult for a subsequent sheet (e.g., sheet 10b) to smoothly slide across the top surface of the first sheet 10a. This problem particularly results when the sheets are output from a processing device, such a laser printer, with the label portion 14 of the form leading. In this situation, there is a tendency for the leading edge 32 of the trailing form 10b to catch on the liner or label portion 14 of the leading form 10a as the trailing form slides across the leading form in the output stacker of the laser printer, as shown in FIG. 2. Thus, the liner 16, together with the adhesive layers 28 and silicon layers 26 increase the thickness of the label portion 14 of the sheet such that they define a step 30, and causes a problem with respect to stacking of the forms in an output stacker, such as on the output of a laser printer. While, only two sheets are shown in FIG. 2, the problem is increased when many such forms are printed and output in a successive manner to an output stacker or the like. The fact that such sheets will not typically stack as desired in an output tray is inconvenient and problematic with respect to the use of such integrated plain paper and label forms and the like.

Thus, improvement in printer blanks, forms and the like having an integrated label are needed for improving stackability thereof. The instant invention solves the above-described problems with prior art blanks and forms by reducing or eliminating the step or lip 30 defined between the plain paper portion and the label portion of such printer blanks and forms.

### SUMMARY OF THE INVENTION

In accordance with the instant invention, the form is redesigned and/or configured such that the step or lip (e.g., lip 30) typically defined by the edge of the label portion of the form is eliminated. More specifically, the plain paper portion of the form is repositioned on the form such that a top surface thereof is substantially even with a top surface of the liner on the label portion of the form. In accordance with a preferred embodiment, the plain paper portion of the form is preferably detached, by cutting or otherwise, from the label portion of the form in a manner that enables the paper portion to be reattached to the form in an overlapping manner. This overlapping configuration increases the thickness of the paper portion of the form adjacent the rear edge of the label portion of the form. The increased thickness of the overlapping section is such that the thickness substantially equals the thickness of the label portion of the form, thereby eliminating or reducing the step or lip (e.g., 30) between the plain paper and label portions of the form. As a result of this overlapping configuration, the catching problem described above that occurs during stacking of the forms after output from a cut sheet processing device, such as a laser printer, is reduced or eliminated.

In accordance with one aspect of the invention, a business form is provided that is suitable for variable printing and includes: a first portion including at least one removable label on a label portion thereof, and an attaching portion extending rearwardly from the label portion, wherein the label portion has a thickness that is greater than a thickness of the attaching portion; and a second portion made substantially of a single sheet that can be printed thereon by a cut sheet printer. A bottom surface of a forward edge of the second portion is secured to a top surface of a rear edge of the attaching portion in a manner that defines an overlapping portion of the business form that is adjacent to the label portion. The overlapping portion has a thickness that substantially corresponds to the thickness of the label portion, thereby defining a substantially smooth top surface for the business form that improves stackability when the forms are output into a stacking tray from a laser printer or the like.

In accordance with another aspect of the invention, a method of producing a business form having at least one label thereon is provided, which includes: providing a first portion of the form including at least one removable label on a label portion thereof, and an attaching portion extending rearwardly from the label portion, wherein the label portion has a thickness that is greater than a thickness of the attaching portion; providing a second portion of the form made substantially of single layer that can be printed thereon by a cut sheet printer; and securing a bottom surface of a forward edge of the second portion to a top surface of a rear edge of the attaching portion in a manner that defines an overlapping portion of the business form that is adjacent to the label portion.

In accordance with another aspect of the invention, a method of producing a business form having at least one label thereon is provided and includes: providing a first portion of the form including at least one removable label on a label portion thereof, and an attaching portion extending rearwardly from the label portion, wherein the label portion has a thickness that is greater than a thickness of the attaching portion; providing a second portion of the form made substantially of a single sheet that can be printed thereon by a cut sheet printer; wherein the first portion and the second portion share a common layer; separating the first portion from the second portion by cutting the common layer; and securing a bottom surface of a forward edge of the second portion to a top surface of a rear edge of the attaching portion in a manner that defines an overlapping portion of the business form that is adjacent to the label portion.

### BRIEF DESCRIPTION OF THE DRAWINGS

These and other objects, features and advantages of the instant invention will become apparent from the following detailed description when read in conjunction with the appended drawings, in which:

FIG. 1a is a top view of a prior art printer blank or form of a type to which the instant invention is applicable;

FIG. 1b is a bottom view of the printer blank or form of FIG. 1a;

FIG. 1c is a side view of the printer blank or form of FIG. 1a;

FIG. 2 depicts a problem that results when two forms of the type shown in FIGS. 1a-1c are successively output into a stacking tray (not shown) from a cut sheet processing device, such as a laser printer;

FIG. 3 shows in improved printer blank or form constructed in accordance with a preferred embodiment of the instant invention; and

FIG. 4 shows the improved stackability of the improved printer blank or form of FIG. 3 when being output to a stacking tray from a cut sheet processing device, such as a laser printer.

### DETAILED DESCRIPTION OF THE PREFERRED EMBODIMENTS

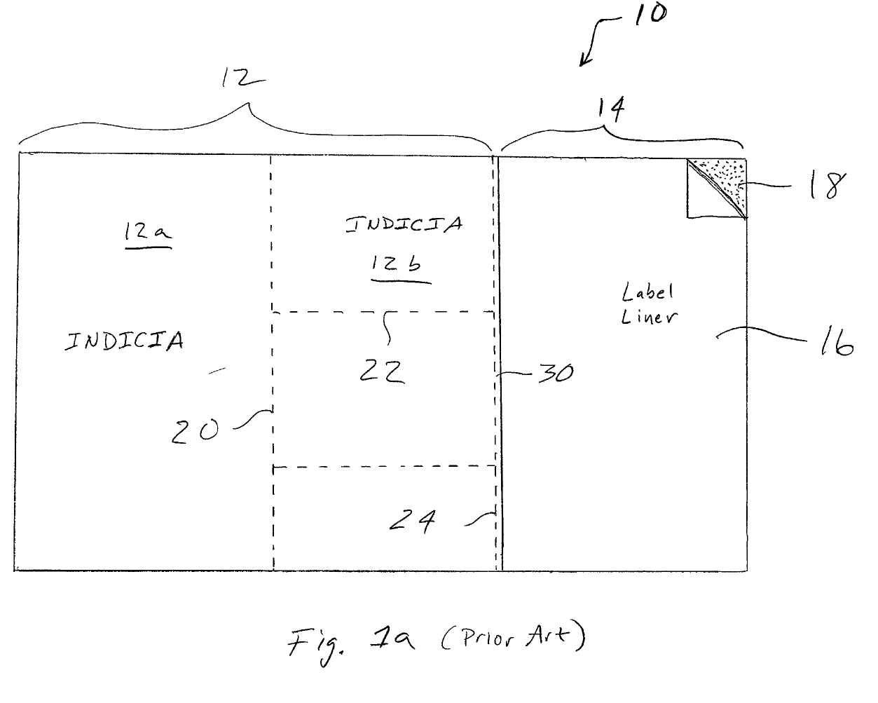

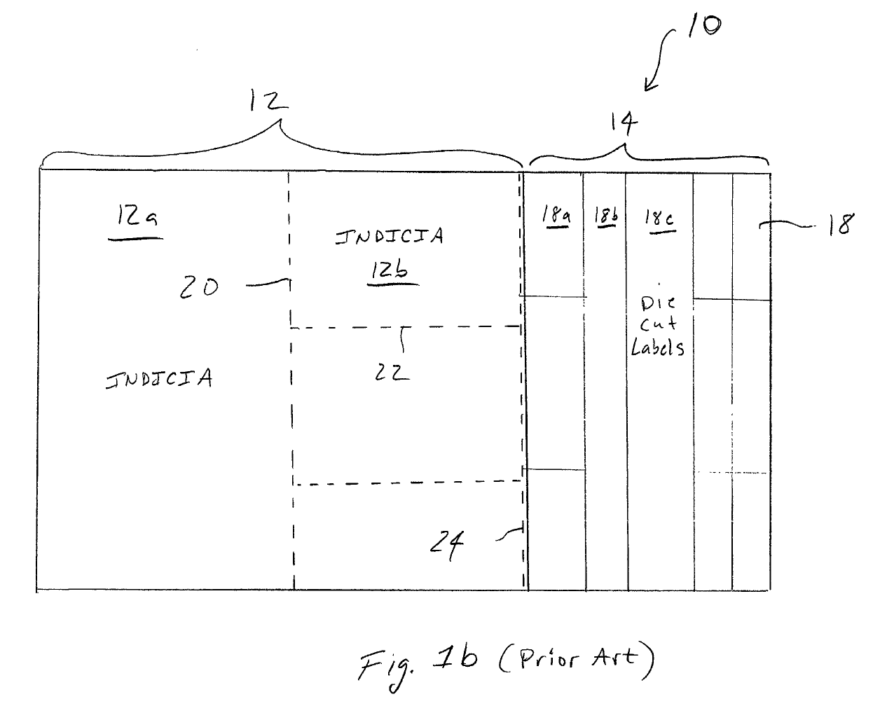

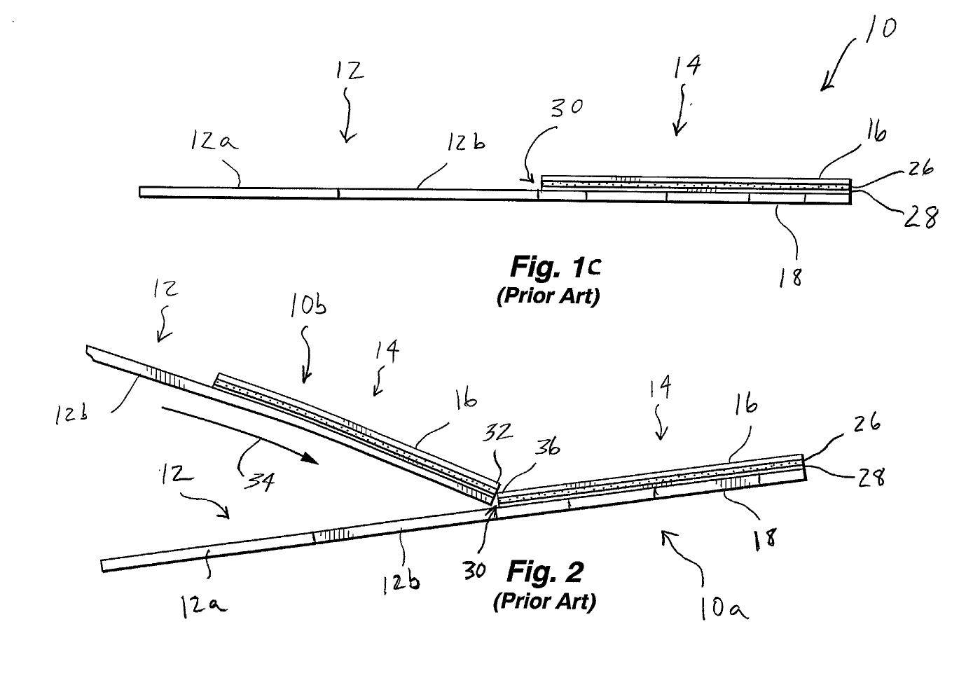

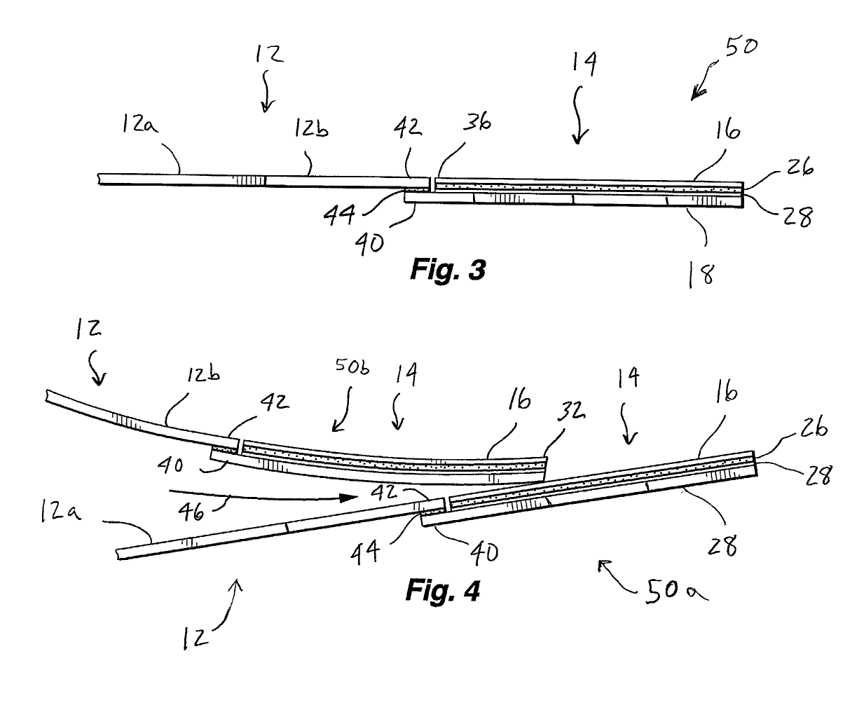

A preferred embodiment of the instant invention will now be described with reference to FIGS. 3 and 4. It is noted that while one particular embodiment of an integrated label printer blank or form 10 has been described above in connection with FIGS. 1a-1c and 2, the instant invention is not limited to this particular configuration or type of form. The instant invention is applicable to any suitable printer blank, form or the like having an integrated label feature for improving the stackability thereof, regardless of the particular configuration of the label component or overall configuration of the blank or form.

FIG. 3 shows a preferred embodiment of the printer blank or form 50 of the instant invention. This embodiment of the invention is similar in design to the exemplary prior art form discussed above and shown in FIGS. 1a-1c and 2. However, the invention is applicable to any other suitable printer blank, form or the like for improving the stackability thereof.

As shown in FIG. 3, the form 50 of the instant invention is redesigned and/or configured such that the step or lip (e.g., lip 30) typically defined by the edge of the label portion of the form is eliminated. In accordance with the present invention, the plain paper portion 12 of the form 50 is repositioned on the form such that a top surface thereof is substantially even with a top surface of the liner 16 on the label portion of the form. More particularly, the plain paper portion 12 of the form is preferably detached, by cutting or otherwise, from the label portion of the form in a manner that enables the paper portion to be reattached to the form in an overlapping manner. This overlapping configuration increases the thickness of the paper portion 12 of the form adjacent the rear edge 36 of the label portion of the form. The increased thickness of the overlapping section is such that the thickness substantially equals the thickness of the label portion of the form, thereby eliminating or reducing the step or lip (e.g., 30) between the plain paper and label portions of the form. As a result of this overlapping configuration, the catching problem described above that occurs during stacking of the forms after output from a cut sheet processing device, such as a laser printer, is reduced or eliminated. In other words, as shown in FIG. 4, the second sheet 50b slides smoothly over the first sheet 50a (in the direction indicated by arrow 46) so that the forms will stack in a neat and orderly fashion after passing through a laser printer or the like.

As seen most clearly in FIG. 3, in this embodiment of the invention, an underside of a forward edge 42 of the plain paper portion 12 of the form 50 is attached to an upper side of an attaching portion 40 that extends rearwardly from the label portion 14 of the form, thereby defining an overlapping configuration. Any suitable adhesive or other suitable means of connecting part 42 to part 40 may be used to secure the form in this overlapping configuration, so that the form can be used is the same manner as, for example, the prior art form shown FIGS. 1a-1c.

The instant invention may be implemented by, for example, starting with a form as shown in FIGS. 1a-1c and cutting the plain paper portion from the label portion in a manner the leaves an attaching portion 40 extending slightly rearwardly from the label portion for use in reattaching the plain paper portion 12 to the label portion in an overlapping configuration as shown in FIG. 3. This method results in the form being slightly shorter after being cut and reattached in the overlapping manner. Alternatively, the label portion and the plain paper portion may be constructed separately and then brought together and secured in the overlapping configuration to achieve the instant invention. It is noted that in this alternative method of construction, the label portion is constructed to include the attaching portion 40 extending rearwardly therefrom so that it is ready to have the plain paper portion attached thereto in the overlapping manner. The attaching portion may be any material, such as, for example, plain paper, label material, liner material or the like.

As can be seen from the above description, the invention can be used to improve the stackability of printer blanks, forms (such as business forms) and the like which have an integrated label element in order to improve the stackability of such forms when being output in a manner the requires the forms to slide across the surface of one another. The invention has particular applicability and usefulness when used in connection with forms that include the label portion at a leading location on the form. The invention may also be implemented in a reverse configuration (not shown) from that shown in FIG. 3, wherein the label rather than the liner is on the top surface of the form, and the catching problem results from a step defined by a rear edge of the label rather than a rear edge of the liner. In this reverse configuration, a similar overlapping configuration, as described above, can also be used in accordance with the instant invention to solve the catching problem.

While the preferred forms and embodiments of the instant invention have been illustrated and described, various changes and modifications may be made without deviating from the true scope of the invention, as one skilled in the art will readily understand and appreciate from the description of the invention herein.

1. A business form suitable for variable printing, comprising:
a first portion including at least one removable label on a label portion thereof, and an attaching portion extending rearwardly from the label portion, wherein said label portion has a thickness that is greater than a thickness of said attaching portion; and
a second portion made substantially of a single sheet that can be printed thereon by a cut sheet printer;
wherein a bottom surface of a forward edge of said second portion is secured to a top surface of a rear edge of said attaching portion in a manner that defines an overlapping portion of said business form that is adjacent to said label portion.

2. The business form of claim 1, wherein said overlapping portion has a thickness that is substantially equal to a thickness of said label portion, thereby defining a substantially smooth top surface for said business form.

3. The business form of claim 1, wherein the bottom surface of the forward edge of the second portion is secured to the top surface of a rear edge of said attaching portion by an adhesive.

4. The business form of claim 1, wherein the label portion includes a plurality of die cut removable labels.

5. The business form of claim 1, wherein the label portion includes a liner layer, a silicon layer, an adhesive layer and a label layer that together define the thickness of said label portion.

6. The business form of claim 1, wherein the second portion of the business form includes a least one score line that enables the second portion to be separated into a plurality of defined parts.

7. The business form of claim 1, wherein the form is designed for use in connection with a pharmacy business.

8. The business form of claim 1, wherein the form includes indicia on the first portion and second portion thereof.

9. The business form of claim 8, wherein the form includes indicia on both an upper and lower surface of said form.

10. The business form of claim 1, wherein said form is a printer blank.

11. A method of producing a business form having at least one label thereon, comprising:
providing a first portion of said form including at least one removable label on a label portion thereof, and an attaching portion extending rearwardly from the label portion, wherein said label portion has a thickness that is greater than a thickness of said attaching portion;
providing a second portion of said form made substantially of a single layer that can be printed thereon by a cut sheet printer; and
securing a bottom surface of a forward edge of said second portion to a top surface of a rear edge of said attaching portion in a manner that defines an overlapping portion of said business form that is adjacent to said label portion.

12. The method of claim 1, further including providing said overlapping portion with a thickness that is substantially equal to a thickness of said label portion, thereby defining a substantially smooth top surface for said business form.

13. The method of claim 1, further including using an adhesive to secure the bottom surface of the forward edge of the second portion to the top surface of a rear edge of said attaching portion.

14. The method of claim 1, further including providing a plurality of die cut removable labels on the label portion of said form.

15. The method of claim 1, further including providing the label portion with a liner layer, a silicon layer, an adhesive layer and a label layer that together define the thickness of said label portion.

16. The method of claim 1, further including providing at least one score line on the second portion of the business form that enables the second portion to be separated into a plurality of defined parts.

17. The method of claim 1, further including configuring the business form for use in connection with a pharmacy business.

18. The method of claim 1, further including providing indicia on the first portion and second portion of the business form.

19. The method of claim 8, further including providing indicia on both an upper and lower surface of said business form.

20. A method of producing a business form having at least one label thereon, comprising:
providing a first portion of said form including at least one removable label on a label portion thereof, and an attaching portion extending rearwardly from the label portion, wherein said label portion has a thickness that is greater than a thickness of said attaching portion;
providing a second portion of said form made substantially of a single sheet that can be printed thereon by a cut sheet printer; wherein the first portion and the second portion comprise a common layer;
separating said first portion from said second portion by cutting said common layer; and
securing a bottom surface of a forward edge of said second portion to a top surface of a rear edge of said attaching portion in a manner that defines an overlapping portion of said business form that is adjacent to said label portion.
